(19) United States
(12) Patent Application Publication
(10) Pub. No.: US 2017/0331915 A1
(43) Pub. Date: Nov. 16, 2017

(54) PROVIDING AN OFFLINE MODE FOR APPLICATIONS AND INTERFACES ACROSS MULTIPLE PLATFORMS

(71) Applicant: SAP SE, Walldorf (DE)

(72) Inventors: Florian Jann, Heidelberg (DE); Kai Richter, Muehltal (DE); Ioannis Grammatikakis, Maxdorf (DE); Alexander Lingg, Heidelberg (DE); Tim Back, Mannheim (DE); Peter Muessig, Untereisesheim (DE); Frank Brunswig, Heidelberg (DE)

(21) Appl. No.: 15/461,296

(22) Filed: Mar. 16, 2017

Related U.S. Application Data
(60) Provisional application No. 62/335,892, filed on May 13, 2016.
(60) Provisional application No. 62/335,895, filed on May 13, 2016.
(60) Provisional application No. 62/335,897, filed on May 13, 2016.
(60) Provisional application No. 62/335,899, filed on May 13, 2016.

(51) Int. Cl. H04L 29/08; G06F 9/44

(52) U.S. Cl. CPC H04L 67/2847; G06F 8/35

(57) ABSTRACT

In one general aspect, a method and system are described that include receiving, at a server device, an indication to operate at least one application in the plurality of applications in an offline mode on the computing device, generating a plurality of requests, generating an offline datastore based on the requests, the data, and the instructions, initializing, in the offline datastore, a plurality of navigation links adapted to operate the at least one application in the offline mode, and generating a hybrid application adapted to be executed in the offline mode or an online mode, the hybrid application adapted, in the offline mode, to provide a web view to operate the at least one application, on the computing device, using the offline datastore and a plurality of offline libraries.

### CROSS REFERENCE TO RELATED APPLICATIONS

This application claims priority to and the benefit of U.S. Provisional Application No. 62/335,892, filed May 13, 2016, U.S. Provisional Application No. 62/335,895, filed May 13, 2016, U.S. Provisional Application No. 62/335,897, filed May 13, 2016, U.S. Provisional Application No. 62/335,899, filed May 13, 2016, each of which is incorporated by reference in its entirety.

### TECHNICAL FIELD

This description generally relates to user interfaces. The description, in particular, relates to systems and techniques for providing a user interface experience for viewing data and information related to multiple software applications.

### BACKGROUND

A user of software applications designed to support processes used by an enterprise often needs to navigate back and forth between multiple (and in many cases different) user interfaces and application instances in order to carry out transactional tasks when making a viable decision for the enterprise. In many cases, the navigation can include viewing data and information related to multiple applications. While navigating between the various user interfaces and application instances, the user may become lost and confused, losing a context of a current transactional task. This can create major usability issues, resulting in the inability of the user to effectively carryout the transactional tasks. In general, the user has a poor user experience using and interacting with the software applications.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a computer-implemented method for providing an offline mode for a plurality of applications executable on a computing device. The method may include receiving, at a server device, an indication to operate at least one application in the plurality of applications in an offline mode on the computing device, generating a plurality of requests, the requests configured to retrieve data and instructions for operating the at least one application using an online datastore, generating an offline datastore based on the requests, the data, and the instructions, initializing, in the offline datastore, a plurality of navigation links adapted to operate the at least one application in the offline mode, and generating a hybrid application adapted to be executed in the offline mode or an online mode. The hybrid application may be adapted, in the offline mode, to provide a web view to operate the at least one application, on the computing device, using the offline datastore and a plurality of offline libraries. Other embodiments of this aspect include corresponding computer systems, apparatus, and computer programs recorded on one or more computer storage devices, each configured to perform the actions of the methods.

Implementations may include one or more of the following features. The method where the hybrid application is further adapted to access offline plugins to operate the at least one application in the offline mode, and where the offline mode enables the at least one application to operate without network access. The method where the offline datastore includes a plurality of instructions to map uniform resource locators to the offline datastore, the uniform resource locators being received from an application layer of the at least one application. The method where the plurality of requests are configured to retrieve data mapped to a service document, the service document being associated with at least one open protocol data service. The method where the plurality of requests include an initialization file having application-specific information and library information for operating the at least one application. The method where the at least one application is enabled for offline use as a prepackaged application built for at least one mobile platform. The method where the offline datastore is synchronized to the online datastore, in response to detecting network connectivity for the device. Implementations of the described techniques may include hardware, a method or process, or computer software on a computer-accessible medium.

The details of one or more implementations are set forth in the accompanying drawings and the description below. Other features will be apparent from the description and drawings, and from the claims.

### BRIEF DESCRIPTION OF THE DRAWINGS

FIG. 1A is an illustration of a user interface entry point (a viewport) for a particular user experience.

FIG. 1B is an illustration showing an example login screen displayed in a shell main container.

FIG. 1C is an illustration showing an example launchpad displayed in a shell main container.

FIG. 1D is an illustration showing an example active application screen (an overview page) displayed in a shell main container.

FIG. 1E is an illustration showing an example object page displayed in a shell main container.

FIG. 1F is an illustration showing an example footer toolbar.

FIG. 1G is an illustration showing an example me area that can be displayed in a left container.

FIG. 1H is an illustration showing an example notification area that can be displayed in a right container.

FIG. 1I is an illustration showing an example copilot user interface.

FIG. 1J is an illustration of a timeline user interface that can display timeline entries.

FIG. 2 is a diagram of an example system that can implement the user interfaces and user experiences described herein.

FIG. 3 is a block diagram of an example architecture for providing offline access to the applications described herein.

FIG. 4 is a flowchart that illustrates a method of providing an offline mode for applications.

Like reference symbols in the various drawings indicate like elements.

### DETAILED DESCRIPTION

Mobile applications, due to the nature of their reliance on wireless networks, may not consistently have the network connectivity to enable real-time access to data. To accommodate this, the systems and methods described herein may allow a web application to have access to particular data while offline. Implementing offline functionality in a mobile application provides several advantages to the end user. Offline functionality for applications enables the use of the application when network connectivity is not available due to technical reasons (e.g., no network coverage) or network connectivity is disallowed (e.g., due to a security). Offline functionality also provides improved performance for data access and manipulation for data that is available locally on the offline device. At the same time, these advantages come with the price of having to download data to the device in advance while network connectivity is available. Such data is generally stored on the device locally and may take a large amount of memory on the device.

Implementation of offline functionality for an application may involve thorough planning in advance consideration of various aspects. For example, a user may plan to include a definition of one or more offline databases, data synchronization strategies, and/or data sets in offline mode. In addition, the user can plan handling of features not available in the offline mode. In some implementations, the systems and methods described herein can adapt existing Open Data Protocol (OData) services to handle offline data requirements to successfully implement offline application usage.

Offline OData may be provided as a service of SAP Mobile Platform (SMP) 3.0 or SAP HANA Cloud Platform mobile services. Such OData services can be used to employ metadata and data models to provide genericized proxies and tools for the developer to develop and for the end user to consume. In addition, the OData services can be used to determine changes in an application and to define functions for reuse of componentry. In general, OData services provide an application-level data access protocol using HTTP as the data transfer protocol.

The offline enablement of an application may include wrapping the application (e.g., web app) into a native container so that native features (e.g., accessing a secure database in the device storage) become available. Such an offline-enabled application may be a hybrid app stored on a mobile device together with the offline data set. The hybrid app may be a native application that is built with Cordova as the native container. It may contain the application (e.g., a FIORI app) with SAP.UI5 resources including, but not limited to core libraries, control libraries, and local Launchpad, as described in detail below. The offline application (e.g., hybrid app) may provide a WebView to run the app.

The WebView may represent a full screen browser tab. The WebView may render HTML and run JAVASCRIPT, but may also allow access to native device functions via the additional plugins described throughout this disclosure. The plugins contain device-specific native code with the JAVASCRIPT libraries on top that can be invoked from the application (e.g., hybrid app).

In general, offline enabled mobile applications can be implemented as a prepackaged application built for one or more selected mobile platforms (e.g., iOS, Android, etc.). The mobile platform can communicate with a set of device application programming interface (API)s that allow a mobile application developer to use JAVASCRIPT to access native device functions, such as the camera or accelerometer.

In some implementations, a prepackaged application as described herein may contain SAP.UI5 libraries with particular application controls and selected plugins extended with a subset of additional plugins to provide access to the native device features for a JAVASCRIPT based application. The additional plugins may contain the features for the offline enablement of particular applications and may contain particular local databases that can store all data utilized for the offline operation of the application (e.g., app).

The offline mode can be used with enterprise transactional applications to provide convenient web-disabled support for users accessing such applications without a network or Internet service. Enterprise transactional applications can evolve from large monolithic on-premise software deployments into multiple (e.g., hundreds of, thousands of) small, componentized applications that can execute (run) on various types of computing devices and network platforms. For example, the fifth version of Hypertext Markup Language (HTML5) can be used as a basis for structuring and presenting an application platform that includes a grid matrix-style home screen or dashboard-like user interface. The use of HTML5 can provide an improved user experience, can reduce a user interface complexity, and may increase user productivity across multiple types of computing devices. The computing devices can include, but are not limited to, desktop computers and mobile computing devices such as laptop computers, tablet computers, notebook computers, personal digital assistants (PDAs), smartphones, mobile phones, smart watches, etc.).

In some cases, the grid matrix-style home screen or dashboard-like user interface allows a user to open and access a selected application. In some cases, the grid matrix-style home screen or dashboard-like user interface allows a user to access content within an application. These user interfaces can present user experience (UX) and user interface (UI) shortcomings while attempting to provide optimized usability and user-centric business functionalities related to transactional tasks.

For example, users may need to navigate back and forth between multiple screens that can include home screens, application instances, and drill downs, in order to perform various transactional tasks to make viable business decisions. The user may need to navigate back and forth between multiple screens when viewing related data between various applications.

For example, applications and application instances may not interoperate with each other. Because of this, user navigation and operations may not be minimized. Applications may not readily access relative content without first needing to open an application instance and then perform numerous navigations.

In order to improve a user experience (UX), a user interface can be implemented to intuitively propose relative context or intent to a user. A user interface can be implemented to conform to, recognize, and facilitate ways in which a user may personally work. A user interface can be implemented to help a user remember important tasks. The use of such a “smart” user interface can help a user easily manage and keep track of the context of current tasks and activities when carrying out transactional tasks.

A shortcoming of a UX and a UI can be a lack of relative business contexts related to user roles and expertise that can empower employees to do their job better, faster, and in a more deliberate way. Providing a user with a way to personalize an experience of the user based on a role requirement of the user can result in a better overall user experience. For example, the personalization can result in a UI automatically providing proposals for transactional tasks that the user may need to see. The proposals can be provided at a time when the user wants to see the proposal and on a computing device chosen by the user. The proposals can be provided to the user as a result of a single click or gesture input to the user interface by the user. The UI can be considered a central interface that can provide a user with the ability to communicate, collaborate, initiate, and/or respond to colleagues, managers, and customers without leaving the context of their current activity or application.

Alternatively, a user may have to navigate through multiple applications and user interfaces. A user may easily lose a context of a current task or activity while having to navigate through user interfaces provided in a multiple application environment for an enterprise. The loss of context can affect the ability of the user to effectively carryout a transactional task. In addition, navigating through user interfaces provided in a multiple application environment may not allow a user to readily view, at a glance, live data that may be relevant to personal and professional daily activities, responsibilities, and organizational accountabilities of the user. The user may not be provided with a way to efficiently manage hundreds (or thousands) of applications associated with transactional workflows in the enterprise.

Enterprise applications that are associated with transactional workflows in an enterprise can be implemented using a software development technology or foundation (e.g., HTML5/CSS/JS technology) in a particular UI framework (e.g., SAPUI5) in order to provide a beneficial UX and UI. The enterprise applications can be implemented to execute or run on multiple different types of computing devices such as desktop computers and mobile computing devices (e.g., laptop computers, tablet computers, notebook computers, personal digital assistants (PDAs), smartphones, mobile phones, smart watches, etc.).

For example, the UI may use elements of a particular UX (e.g., an SAP Fiori® UX) to provide a user with a personalized, responsive, seamless, and simple user experience across enterprise applications (including legacy and new), across different types of computing devices such as desktop computers and mobile computing devices (e.g., laptop computers, tablet computers, notebook computers, personal digital assistants (PDAs), smartphones, mobile phones, smart watches, etc.), and across all possible deployment options (e.g., on-premise, cloud, as-a-service, etc.).

The particular UX can deploy an array of interactive features and process tools that can be integrated with a suite or set of enterprise applications that have specific functionalities. The particular UX can provide intelligent, contextual-based support for users across an enterprise. The particular UX can use a “push” model that can anticipate tasks (e.g., transactional tasks) for a user based on a role of the user in the enterprise. The particular UX can import real-time data that can be tailored to specific tasks. The software for the UI for the particular UX can be implemented to easily and transparently scale the UI accordingly for display on each display device included in each of the different possible computing devices that can execute (run) the enterprise applications.

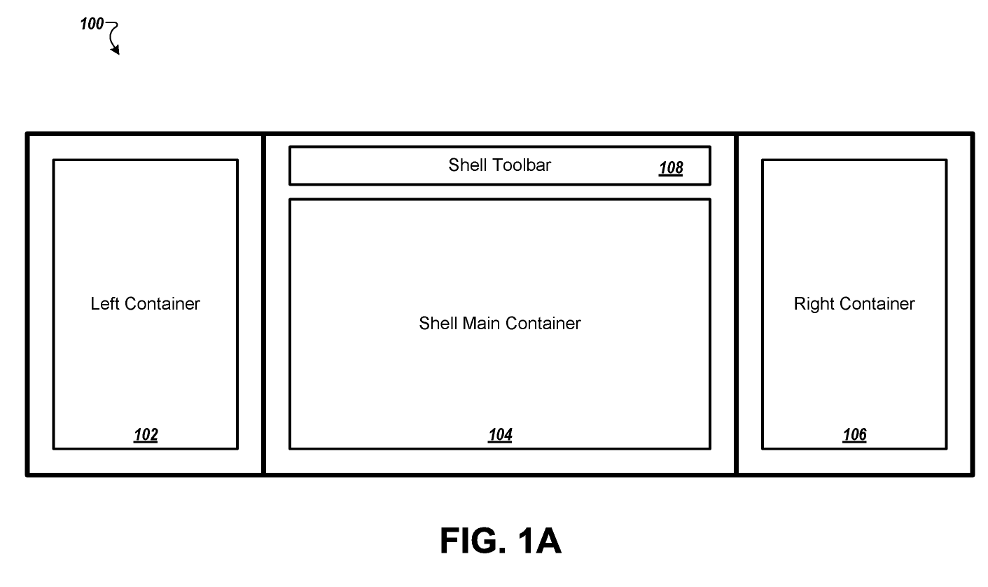

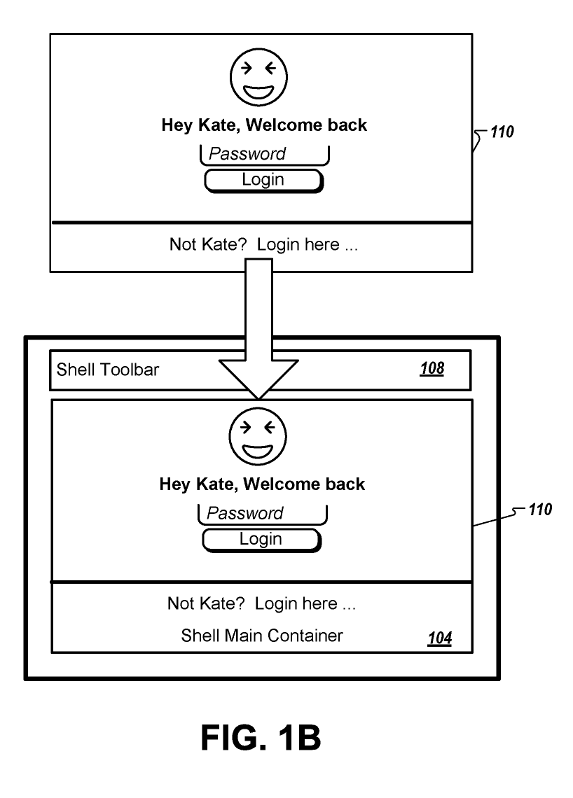

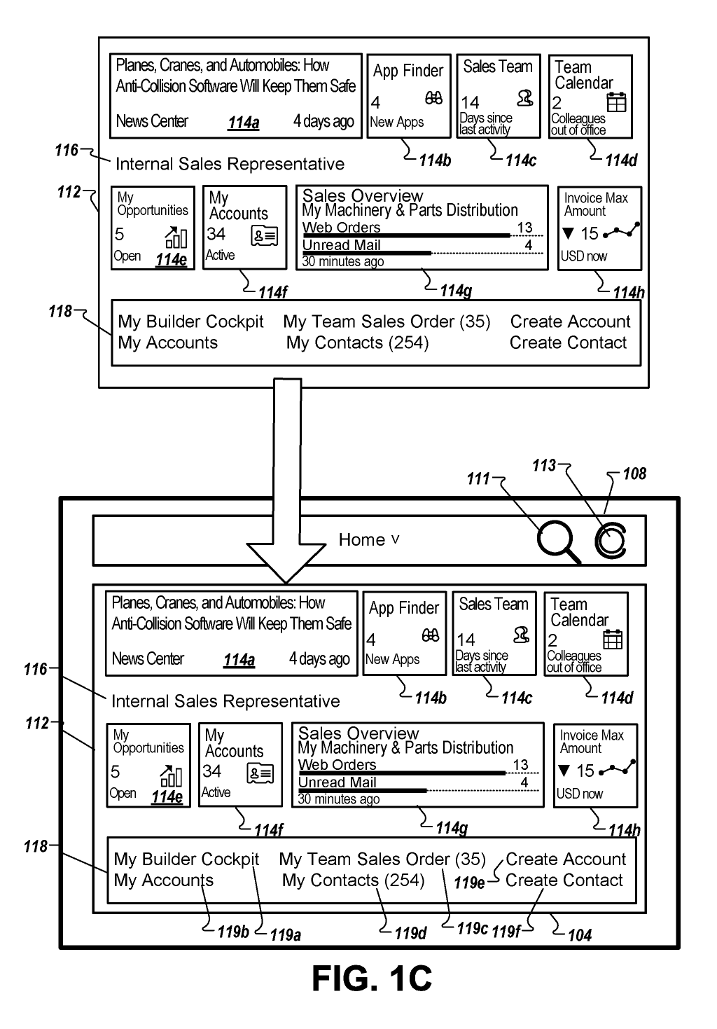

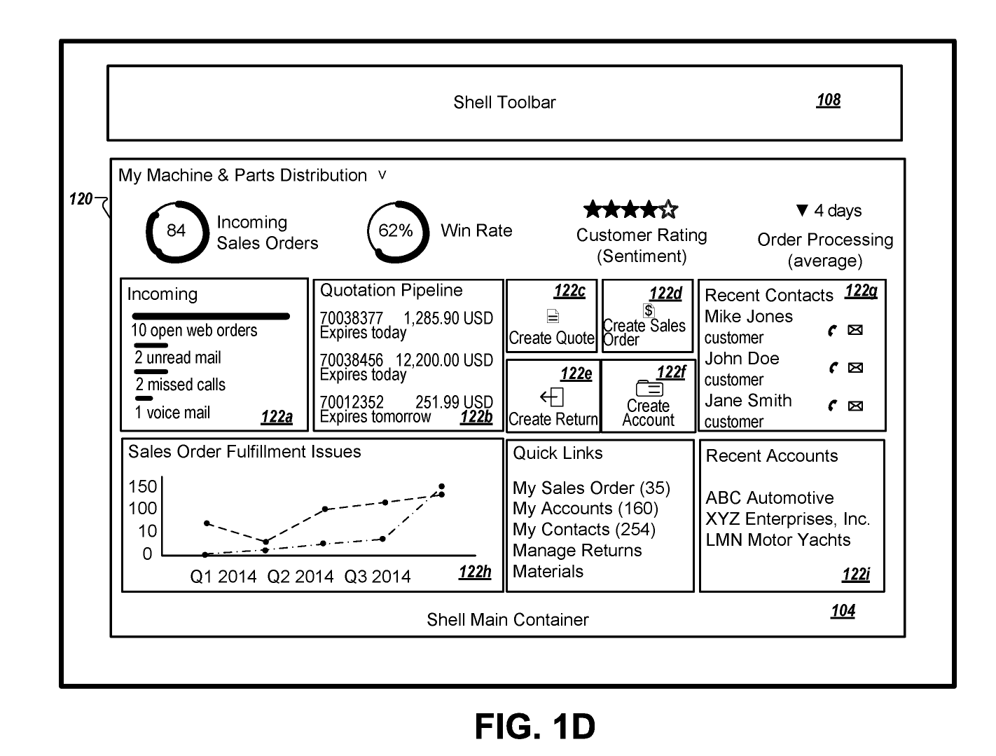

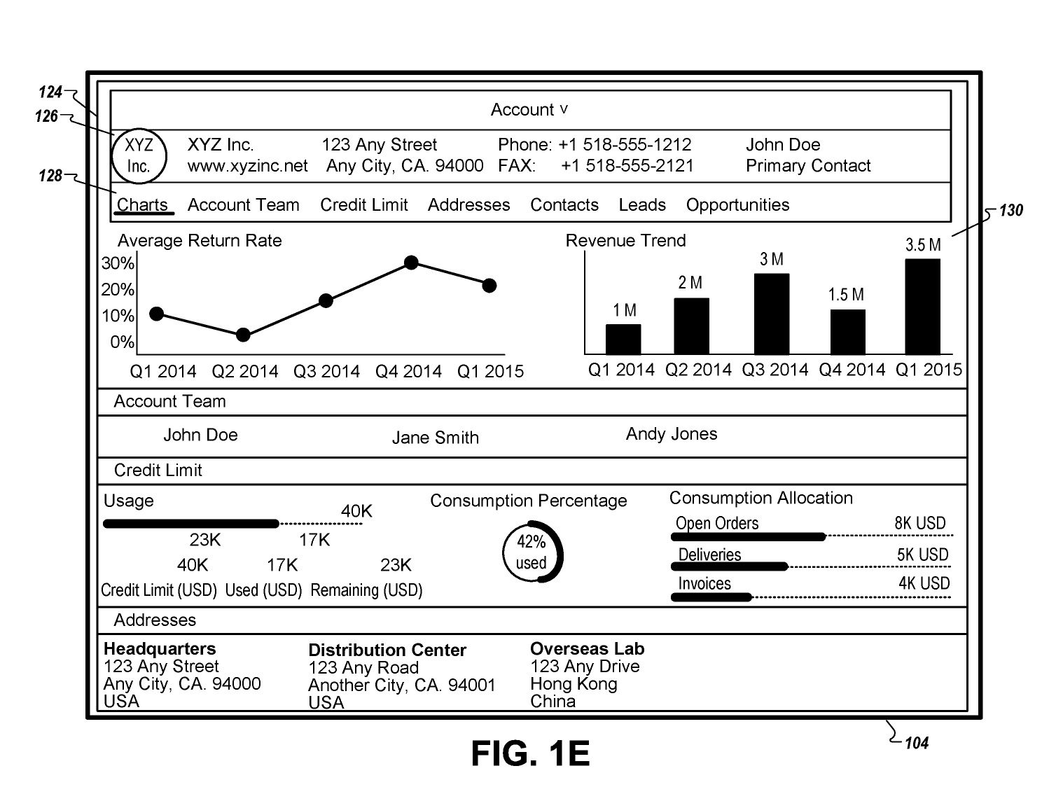

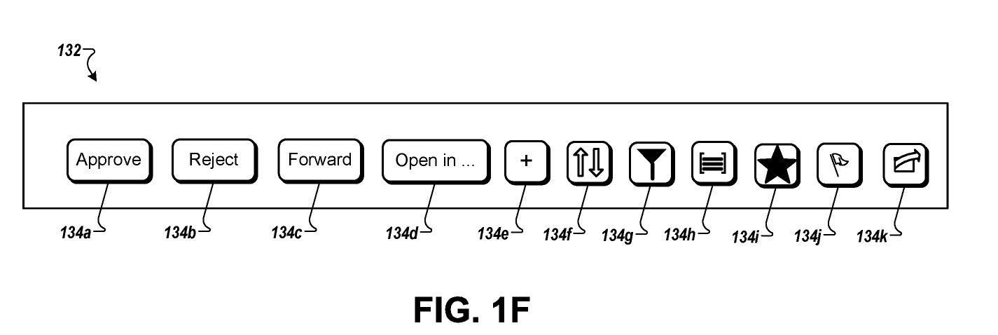

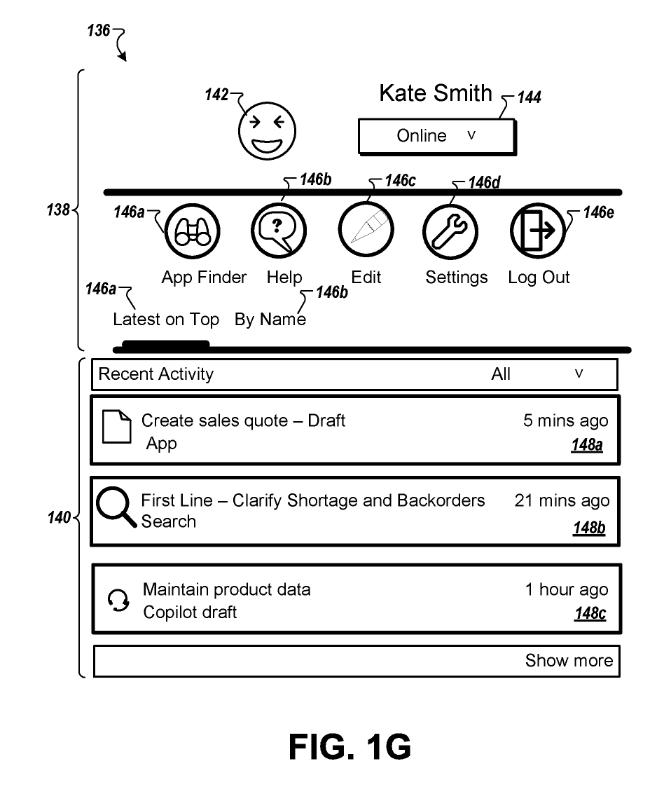

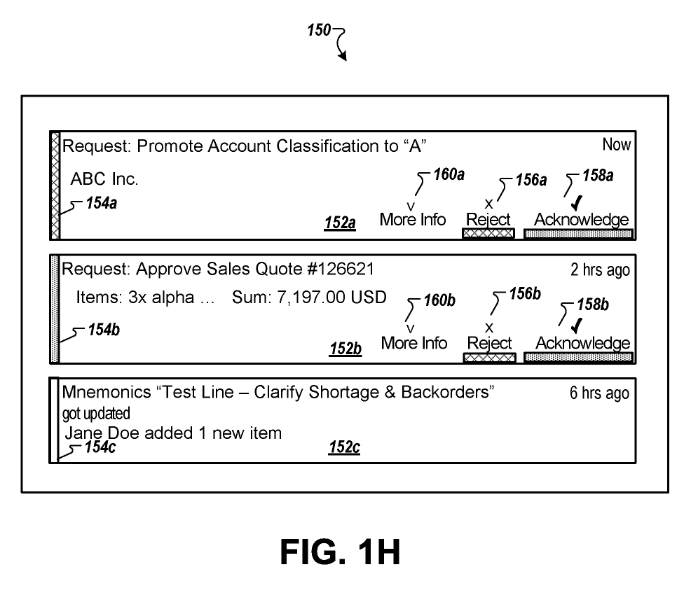

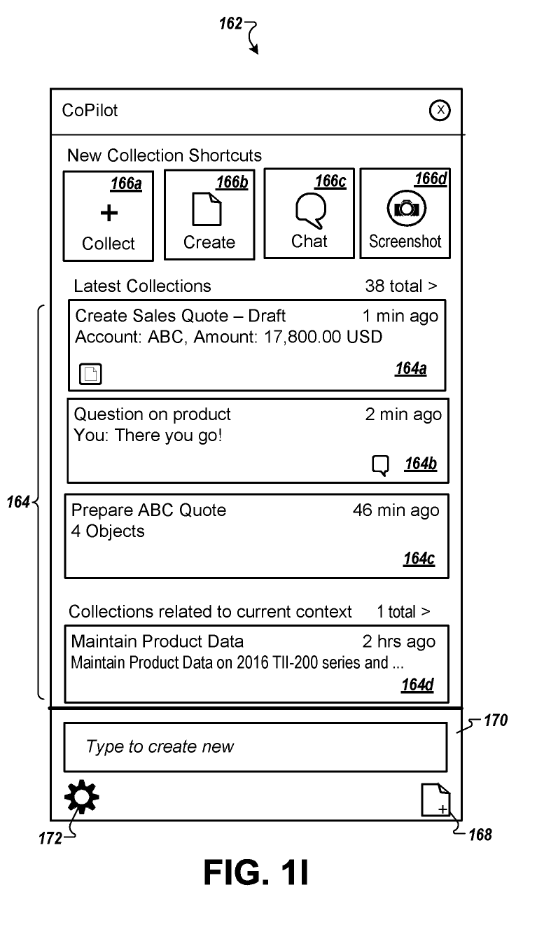

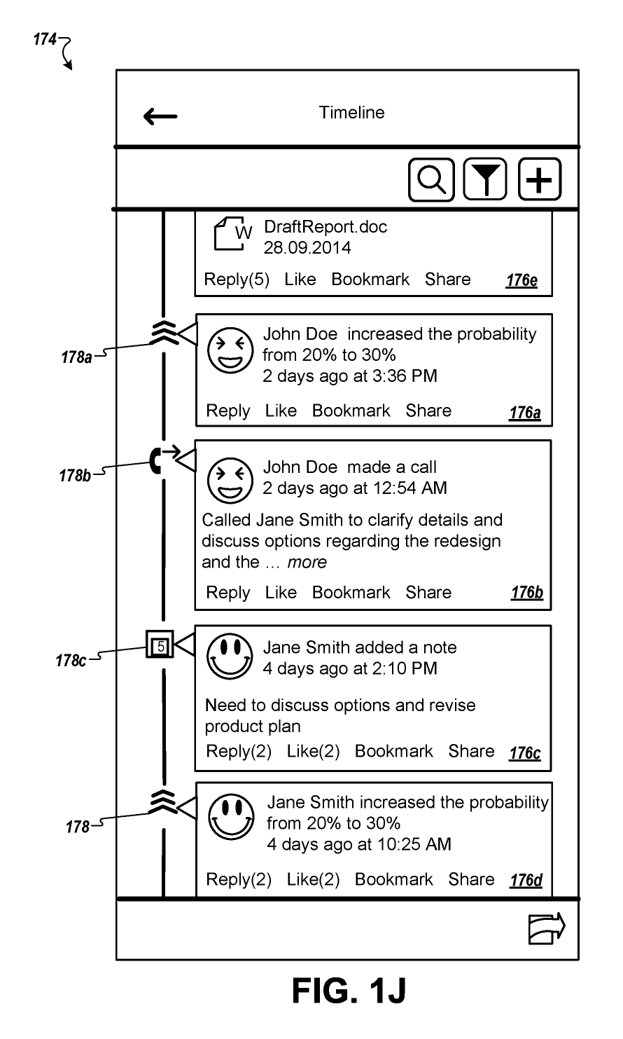

FIG. 1A is an illustration of a UI entry point (a viewport 100) for a particular UX. The viewport 100 can be a single-screen view partitioned into multiple (e.g., three) multifunctional screen areas (e.g., a left screen area (left container 102, a center screen area (shell main container 104), and a right screen area (right container 106) for display in a display area (on a display device) included in a computing device. The viewport 100 can include a shell toolbar 108. The shell toolbar 108 can include a global search and other services, which are available to a user across all enterprise applications.

The shell main container 104 can display information for use as a main workspace for the UX. In some implementations, multiple different screens can be displayed in the shell main container 104. For example, a login screen, a launchpad screen, and an overview page can alternatively be displayed in the shell main container 104. The viewport 100 can provide a user with a screen orientation that can allow the user access to application information. The viewport 100 can provide the user with a UX and UI the includes the business functionalities and enterprise application-to-application navigations needed by the user without disrupting a context of a current task of the user.

FIG. 1B is an illustration showing an example login screen 110 displayed in the shell main container 104. The login screen 110 provides a UI that allows a user to enter credentials in order to log into and begin a personalized and customized UX. In the example shown in FIG. 1B, the login screen 110 appears to drop into the shell main container 104 from a virtual extension area located along a top of a display area. In some implementations, the virtual extension area can be placed along the bottom of the display area. In some implementations, the virtual extension area can be placed to the left and/or the right of the display area.

FIG. 1C is an illustration showing an example launchpad 112 displayed in the shell main container 104. The launchpad 112 can be a web-based entry point (or homepage) for enterprise applications that can execute (run) across multiple platforms and computing devices. In the example shown in FIG. 1C, the launchpad 112 appears to drop into the shell main container 104 from the top of a display area. In some implementations, the virtual extension area can be placed along the bottom of the display area. In some implementations, the virtual extension area can be placed to the left and/or the right of the display area.

The launchpad 112 can serve as a bracket around (or a base for) a set (or group) of enterprise applications, providing a single point of entry for the set of enterprise applications. In the example shown in FIG. 1C, the launchpad 112 presents (displays on a screen of a computing device of a user) each application represented by a tile. A tile can be a container that represents the application. Each tile can display different types of content. A user can interact with each tile to navigate to the specific enterprise application associated with the tile. In addition, when designing a tile to represent a specific application, a programmer can assign a tile to a specific user or group of users. The launchpad 112 can provide one or more services. The one or more services can include, but are not limited to, application-to-application navigation, personalization, role-based application assignments, search, and incident creation.

The launchpad 112 can be a role based, personalized, real-time and contextual aggregation point for business applications and analytics. The launchpad 112 can run (execute) on multiple computing devices including, but not limited to, desktop computers and mobile computing devices such as laptop computers, tablet computers, notebook computers, personal digital assistants (PDAs), smartphones, mobile phones, smart watches, etc.). In addition, the launchpad 112 can be deployed on multiple platforms (e.g., Linux, Windows, Windows Phone, MAC®, iOS®, OS X®, Android®, etc.).

The launchpad 112 includes tiles 114a-h. Each tile can display different types of content. For example, tile 114a can be a news and feeds tile that can enhance collaboration by providing a user with information about the enterprise. The tiles 114a-h can be individually color-coded. A color can represent a particular role (e.g., finance, human resources, supply chain management (SCM), customer relationship management (CRM), etc.). The tiles 114a-h can be associated with a group 116. Tile 114f can be a key performance indicator (KPI) tile. Tile 114b can be a basic launch tile. Tile 114d can be a monitoring tile. Tile 114g can display a comparison chart for specific content.

The launchpad 112 includes a link list area 118 that includes links 119a-f. The link list area 118 is an area on the launchpad 112 that can provide links to enterprise applications represented by the tiles 114a-h. For example, a user can select and drag a tile from the tile area on the launchpad 112 into the link list area 118 to create a link to the application associated with (represented by) the tile. In some implementations, the launchpad 112 can include a footer toolbar (e.g., footer toolbar 132 as shown in FIG. 1F). In some implementations, the footer toolbar can appear to float over the content displayed in the launchpad 112.

In some implementations, the shell toolbar 108 can display a search icon 111 and a copilot launch icon 113. A user can select (click on) the copilot launch icon 113 to launch a copilot UI. A copilot UI will be described in more detail with reference to FIG. 1I.

FIG. 1D is an illustration showing an example active application screen (overview page 120) displayed in the shell main container 104. The enterprise applications that can be accessed by a user by way of the launchpad 112 and then subsequently displayed in an active application screen (e.g., the overview page 120) can include, but are not limited to, transactional applications, analytical applications, and fact sheet applications (contextual navigation applications). Transactional applications can allow a user to create, change and/or approve processes with guided navigation. Analytical applications can provide a user with a visual overview of a dedicated topic for monitoring and tracking purposes to allow for further key performance indicator (KPI) related analysis. Fact sheet applications can allow a user to view essential information about an object and to allow navigation between related objects.

The overview page 120 can visualize all of the information a user may need for a specific business context (business domain) on a single page or screen. The information can be displayed in one or more variable content packages (VCPs) or cards 122a-i. Each card can be a container of content for organizing large amounts of information on an equal plane within the overview page 120. In some implementations, a user can rearrange the position of the cards 122a-i on the overview page 120. In some implementations, a user define, add, or delete cards included in the overview page 120.

An overview page (e.g., the overview page 120) can be a selectable application (e.g., from the launchpad 112) providing an integrated gateway into enterprise applications and application content included in the launchpad 112. The UI of the overview page (e.g., the overview page 120) can provide a user with a visual summary of data, links, actions, and content that are relevant to a business domain of expertise of a user and relevant to a selected role of the user within the domain. The visual summary can be presented in one or more cards (e.g., the cards 122a-i) that display live content to a user at-a-glance without the user having to open multiple applications and perform multiple drill downs through application content to find and present the content.

In some implementations, the overview page 120 can include a footer toolbar (e.g., footer toolbar 132 as shown in FIG. 1F). In some implementations, the footer toolbar can appear to float over the content displayed in the overview page 120.

In some implementations, an enterprise system can determine content displayed on an overview page (e.g., the overview page 120). In addition or in the alternative, a selection of one or more business domains and one or more roles of a user in the business or enterprise can determine content displayed on an overview page (e.g., the overview page 120). In some implementations, a user can make the selection using a settings UI included in a launchpad (e.g., the launchpad 112). In some implementations, a user can select one or more business domains and/or one or more roles of the user in the enterprise by way of an overview page (e.g., the overview page 120). Selecting one or more business domains and/or one or more roles of the user in the enterprise by way of the overview page can maintain absolute relevance to the individual user and the way in which the user works.

In some implementations, the user can personalize the layout and placement of one or more cards (e.g., the cards 122a-i) included in a UI of an overview page (e.g., the overview page 120) and the display of content included in each card. The personalization can enhance the workplace productivity of the user.

FIG. 1E is an illustration showing an example object page (object page 124) displayed in the shell main container 104. An object page can be a floor-plan used to represent objects in a UI. An object page can be used to display, create, or edit an object. An object can represent a business entity (e.g., a customer, a sales order, a product, an account, etc.). Enterprise applications that reflect a specific scenario (e.g., a sales order, am account status) can be bundled using an object. The object page can include a header area 126, a navigation area 128, a content area 130, and, in some implementations, a footer toolbar (e.g., footer toolbar 132 as shown in FIG. 1F). In some implementations, the footer toolbar can appear to float over the content displayed in the object page 124. For example, referring to FIG. 1C, a user can select the tile 114f and an object page can be displayed to the user.

FIG. 1F is an illustration showing an example a footer toolbar (e.g., footer toolbar 132). In some implementations, referring to FIG. 1A, the footer toolbar 132 can appear at the bottom of a screen displayed in the shell main container 104, the left container 102, and/or the right container 106. For example, as described herein with reference to FIGS. 1C-E, a footer toolbar (e.g., the footer toolbar 132) can be displayed at the bottom of the launchpad 112, the overview page 120, and the object page 124. The footer toolbar (e.g., the footer toolbar 132) can continue to appear at the bottom of the screen of the display area of the display device even as the displayed screen is scrolled. The footer toolbar (e.g., the footer toolbar 132) can appear to hover over or float over the content being displayed on the screen. The footer toolbar 132 can include buttons or controls 134a-k. The controls 134a-k can be selected by a user in order to perform one or more actions that can impact content included on the page being displayed on the screen. The controls 134a-k are examples of controls that can be included in a footer toolbar. In some implementations, the controls can be different, fewer than, or more than the controls 134a-k. The type and number of controls included in a footer toolbar can be based on the type of page being displayed and/or the content being displayed in the page.

FIG. 1G is an illustration showing an example me area (e.g., me area 136) that can be displayed in the left container 102. In some implementations, the me area 136 can be displayed in the right container 106. The me area 136 includes an upper section 138 and a lower section 140. The upper section 138 includes a user icon 142. Selecting (clicking on) the user icon 142 can provide a user profile. A dropdown indicator button 144 displays a status of the user and, if selected, a user can logout of an application. The upper section 138 includes navigation targets 146a-e. Selection of (clicking on) a navigation target by a user triggers a corresponding functionality (e.g., an application) associated with a navigation target. The me area 136 can provide various generalized functionalities as they are related to a user.

The upper section 138 can include sort selections 146a-b. A user can select (click on) a sort selection (e.g., one of the sort selections 146a-b) to determine how the listing of the recent activities included in the lower section 140 will be sorted and displayed.

The lower section 140 of the me area 136 includes a list of recent activities 148a-c. The recent activities 148a-c can include links 156a-c, respectively, that when selected (clicked on) by a user can navigate the user to back to the shell main container 104, opening an application (or function) that corresponds to the link in the shell main container 104. Recent activity items can include, but are not limited to, enterprise applications, triggered searches, co-pilot collections, and co-pilot drafts.

FIG. 1H is an illustration showing an example notification area (e.g., notification area 150) that can be displayed in the right container 106. In some implementations, the notification area 150 can be displayed in the left container 102. The notification area 150 includes notifications 152a-c. A user interacting with the UI in the notification area 150 can take immediate action on a notification. A notification item (e.g., notifications 152a-c) can have an indicator (e.g., notification indicators 154a-c) that can indicate the status of the notification. For example, a notification indicator can be color coded to indicate a particular status of the notification.

A user can reject a notification by selecting (clicking on) a reject selection (e.g., a reject selection 156a-b). For example, a user can reject the notification 152a by selecting (clicking on) the reject selection 156a. The rejection of the notification 152a (the notification status) can be indicated by content included in (e.g., a color of) a notification indicator 154a. A user can acknowledge a notification by selecting (clicking on) an acknowledge selection (e.g., a acknowledge selection 158a-b). For example, a user can acknowledge the notification 152b by selecting (clicking on) the acknowledge selection 158b. The acknowledgement of the notification 152b (the notification status) can be indicated by content included in (e.g., a color of) a notification indicator 154b.

A user can drill down into a relevant application by selecting (clicking on) a more info selection (e.g., a more info selection 160a-b). In some cases, a user may contact someone directly in response to a notification.

FIG. 1I is an illustration showing an example copilot UI (e.g., copilot UI 162). For example, referring to FIG. 1C, a copilot application can be launched from the launchpad 112 when a user selects (clicks on) the copilot launch icon 113. The copilot application can provide (generate and display) the copilot UI 162. In some cases, the copilot UI 162 can float over the UI included in the launchpad 112. As a floating UI control, the copilot UI 162 can be visually unobtrusive and flexible in its cross-functional omnipresent implementation across any device or application screen.

The example copilot UI 162 is an example copilot start page or start screen. The start screen (the copilot UI 162) can be an entry point for copilot functionality for an enterprise system.

The copilot UI 162 can provide shortcuts to different copilot features. For example, as shown in FIG. 1I, a collection can be represented by an entry in a collection list 164 that includes collection list entries 164a-d. A copilot collection can be a cluster of items in relation to a specific topic. For example, an item can be a note, a screenshot, a chat message, a copilot message, an object, or a quick create. In some implementations, the items included in the collection can be homogeneous (e.g., all of the items are of the same type). In some implementations, the items included in a collection can be non-homogeneous (e.g., the items can be of different types). Each collection list entry 164a-d can provide a representation of a collection that can include a title, a timestamp (e.g., last changed), a visual content summary, and a textual content preview. In some implementations, the collection list 164 can be searched and/or filtered.

For example, the selection of a copilot shortcut 166a-d can allow a user to create and navigate to a new collection with a specified intention. The selection of a copilot create icon 168 located in a copilot footer toolbar 170 can create and navigate to a new plain collection. The selection of a copilot settings icon 172 located in the copilot footer toolbar 170 can allow a user access to copilot settings (e.g., display a copilot settings UI, open a copilot settings application, etc.).

Copilot entries can be living, gradually growing artifacts and software entities that can accompany a user from the identification of an issue to a solution for the issue, while providing support in the form of relevant context and actions. Copilot entries can serve as memory aides while the copilot entries can incrementally evolve into valuable transactional tasks and collaborations as they mature in meaningful ways that bridge a gap between predefined application functionality and processes based on personal ways of working for a user. Though the example shown in FIG. 1I describes launching the copilot application from the launchpad 112, referring to FIG. 1A, the copilot application can be launched from other screens displayed in (included in) the shell main container 104, the left container 102, and/or the right container 106.

Copilot entries can be made ready for users to use when communicating, collaborating, and creating actionable transactions in desktop or mobile scenarios. For example, copilot text entries can be analyzed for recognizing and identifying relevant text related objects. Copilot text entries can emphasize displayed text, and a copilot application can recommend contextual entities for use in a current task. The copilot application can understand user context and can intelligently propose selections, auto-entries, and user options.

A smart template can provide a framework for generating user interfaces at runtime for an enterprise application. For example, a smart template can be used to generate the UI for the overview page 120 as shown in FIG. 1D. In another example, a smart template can be used to generate the UI for the object page 124, as shown in FIG. 1E. A smart template can provide a framework for generating the user interfaces based on metadata annotations and predefined templates for the most used application patterns. The use of smart templates can ensure design consistency by providing centralized high quality code by using predefined templates and controllers. The use of smart templates can keep applications up to date with evolving design guidelines. The use of smart templates can reduce an amount of front-end code used in building enterprise applications. The term “smart” can refer to annotations that add semantics and structures to provided data. The term “smart” can also refer to the way in which the templates understand the semantics.

FIG. 1J is an illustration of a timeline UI (e.g., the timeline 174). A timeline UI (e.g., the timeline 174) can display timeline entries 176a-e. For example, the entries can be events, objects, and/or posts listed and displayed in a chronological order. The timeline 174 includes nodes 178a-d that correspond to respective timeline entries 176a-d.

The timeline 174 can be used for collaborative communications. The timeline 174 can be configured in multiple different ways depending on use case implementations. For example, the timeline 174 can provide information about changes of an object or about events related to an object. The timeline 174 can provide information about generated entries (e.g., value XY changed from A to B) or about manual entries (e.g., comments from an individual). In some implementations, the latest entry is at the top of a list displayed by a timeline. In some implementations, the timeline 174 can be displayed along with a business object. In some cases, the timeline 174 can be displayed to the right of the business object.

Two example versions of a timeline can include a basic timeline and a social timeline. A basic timeline can be a read-only timeline. A social timeline can allow for interaction and collaboration among users.

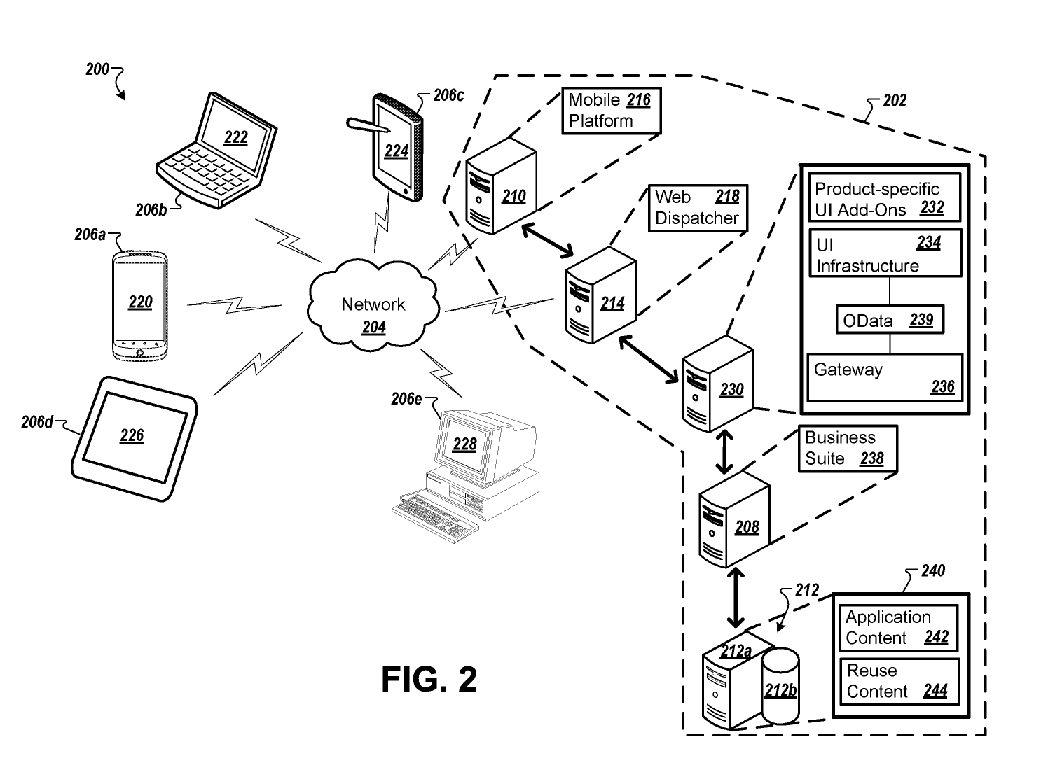

FIG. 2 is a diagram of an example system 200 that can implement the user interfaces and user experiences described herein. The system 200 includes an enterprise computing system 202, a network 204, and client computing devices 206a-e.

For example, computing device 206a can be a mobile phone, a smartphone, a personal digital assistant, or other type of mobile computing device. The computing device 206a includes a display device 220. For example, computing device 206b can be a laptop or notebook computer. The computing device 206b includes a display device 222. For example, computing device 206c can be a tablet computer. The computing device 206c includes a display device 224. For example, the computing device 206d can be a wearable device such as a smartwatch. The computing device 206d includes a display device 226. For example, the computing device 206e can be a desktop computer. The computing device 206e can include a display device 228. A user of the computing devices 206a-e can use/interface with the display devices 220, 222, 224, 226, and 228, respectively, when interacting with the enterprise computing system 202. The computing devices 206a-e can display on the display devices 220, 222, 224, 226, and 228 any of the screens and UIs described herein.

The enterprise computing system 202 can include one or more computing devices such as a web management server 214, a frontend server 230, a backend server 208, and a mobile device management server 210. The enterprise computing system 202 can also include a database management computing system 212 that includes a database management server 212a and a database 212b. Though not specifically shown in FIG. 2, each server (the web management server 214, the frontend server 230, the backend server 208, the mobile device management server 210, and the database management server 212a) can include one or more processors and one or more memory devices. Each server can run (execute) a server operating system.

In some first implementations, the client computing devices 206a-d (e.g., the mobile computing devices) can communicate with the enterprise computing system 202 (and the enterprise computing system 202 can communicate with the client computing devices 206a-d) by way of the mobile device management server 210. The mobile device management server 210 includes one or more mobile device platform application(s) 216. By using the mobile device platform application(s) 216, the enterprise computing system 202 can deliver cross-platform, secure, and scalable applications to the computing devices 202a-d, independent of the mobile computing device-type (e.g., laptop, notebook, smartwatch, mobile phone, PDA, etc.) and independent of the operating system running on the computing device 206a-d. In these implementations, the mobile device management server 210 can then communicate with the web management server 214.

In some second implementations, the client computing devices 206a-e (both the mobile computing devices (computing devices 206a-d) and the desktop computing device 206e) can communicate with the enterprise computing system 202 (and specifically with the web management server 214), and the enterprise computing system 202 (and specifically with the web management server 214) can communicate with each of the client computing devices 202a-e) using the network 204. The web management server 214 includes a web dispatcher application 218. In both the first implementations and the second implementations, the web dispatcher application 218 can act as a “software web switch” accepting or rejecting connections to the enterprise computing system 202.

In some implementations, the network 204 can be a public communications network (e.g., the Internet, cellular data network, dialup modems over a telephone network) or a private communications network (e.g., private LAN, leased lines). In some implementations, the computing devices 206a-e can communicate with the network 204 using one or more high-speed wired and/or wireless communications protocols (e.g., 802.11 variations, WiFi, Bluetooth, Transmission Control Protocol/Internet Protocol (TCP/IP), Ethernet, IEEE 802.3, etc.).

The frontend server 230 can include product specific UI Add-On Applications 232 and a UI infrastructure 234. The UI infrastructure 234 can include a design portion and a runtime portion. The frontend server 230 can decouple a lifecycle of a UI (e.g., design and runtime deployment) from the backend server 208. The decoupling can allow UI applications to interface with a plurality of different databases. The decoupling provides a single point of UI design, access, and maintenance allowing for theming, branding, configuring, and personalizing a UI without a need for development privileges to the backend server 208 (e.g., no need to have backend administrative rights). The decoupling can result in a more secure enterprise computing system. The decoupling can provide for rule-based dispatching of requests in a multi-system landscape (e.g., for approvals including aggregation).

The frontend server 230 includes a gateway 236. The gateway 236 can provide a way to connect devices, environments, and platforms to enterprise software based on market standards. The gateway 236 can enable the development of UIs for use in different environments (e.g., social and collaboration environments). The gateway 236 can enable the development of UIs for use on different types of client computing devices (e.g., client computing devices 206a-e). The gateway 236 can enable the development of UIs for use in internet-based and offline applications.

The frontend server 230 includes OData services (e.g., Open Data Protocol) services 239. OData services 239 are typically resource-oriented and all artifacts are network accessible objects that are identified by a Uniform Resource Identifier (URI) or an Internationalized Resource Identifier (IRI). The entry resource of an OData Service may be a service document. The service document may be the top level representation of an OData service. The service document may list entity sets, singletons, and functions of the same services. Resources provided in the service document may be accessed with a URL that may be the concatenation of the base URL and the resource URL.

In some implementations, OData services 239 may represent OData services that can provide aggregation services, dimensional services, measuring services, and parameter passing services. In some implementations, OData services can also provide analytical services such as currency conversion, formula calculation, totaling services, hierarchy analysis, and write-back services.

In some implementations, OData services 239 may provide offline access to a number of applications. The backend server 208 can include a bundle (a set) of business applications (e.g., business suite 238). The business applications can be transactional applications. analytical applications, and fact sheet and contextual navigation applications. Transactional applications can allow task-based access to tasks that can include create and change. In addition or in the alternative, transactional applications can allow access to entire processes with guided navigation. Analytical applications can provide a user with a visual overview of complex tasks for monitoring and tracking purposes. Fact sheet applications and contextual navigation applications involve search and explore activities. Fact sheet applications and contextual navigation can allow a user to view essential information about an object and can allow contextual navigation between related objects.

The database management computing system 212 includes a database management server 212a that can run (execute) applications that can manage a database 212b. For example, the database 212b can be an in-memory, column-oriented, relational database (e.g., SAP HANA®). The database management computing system 212 can include extended application services 240 that can embed a full featured application server, web server, and development environment within the database management computing system 212. The extended application services 240 can include application content 242 and reuse content 244 for use by the enterprise computing system 202 when providing a personalized, responsive, and simple UX across different types of computing devices and deployment options.

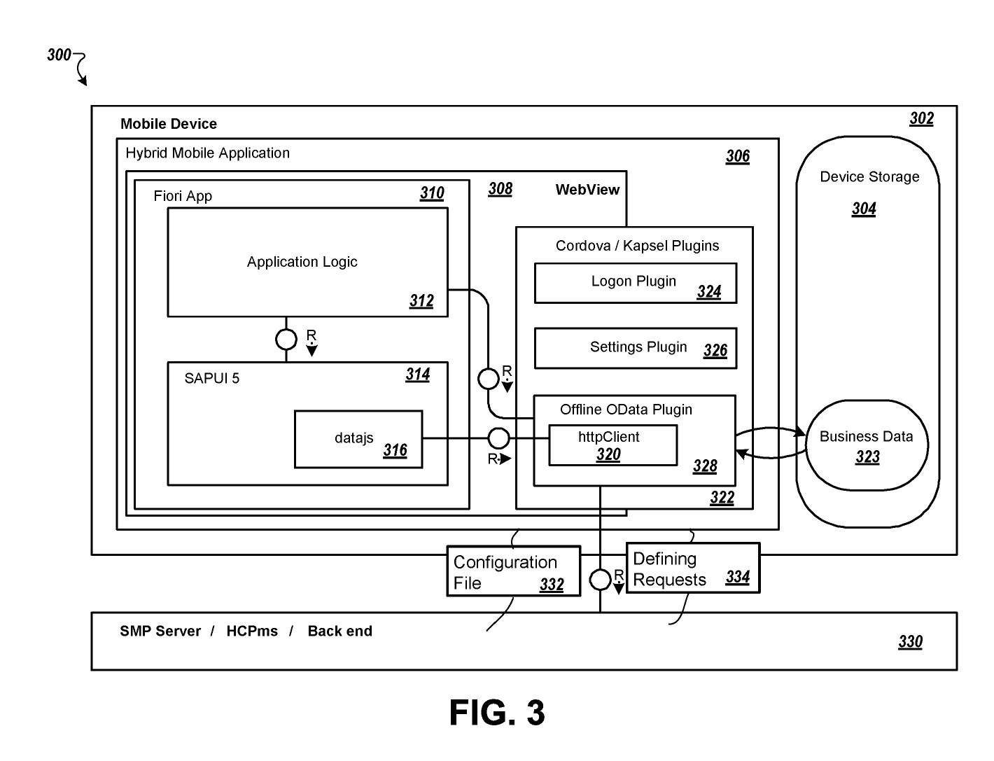

FIG. 3 is a block diagram of an example architecture 300 for providing offline access to the applications described herein. The architecture 300 is shown executing on a mobile device 302. The mobile device 302 includes device storage 304 and access to a hybrid mobile application 306 executing in memory (e.g., within storage 304 or another memory) on the operating system of the device 302.

The hybrid mobile application 306 provides access to WebView 308, which represents a browser tab. For example, WebView 308 may represent a full screen (e.g., maximized) browser tab opened on device 302 and running in an offline (e.g., non-Internet or network connected) mode. In operation, the WebView 308 may render HTML and run JAVASCRIPT. The WebView 308 can invoke one or more applications 310. The applications 310 can invoke application logic 312 and SAP.UI5 logic 314. SAP.UI5 logic 314 can use libraries such as datajs 316. For example, the SAP.UI5 based applications can use datajs (an open source, third-party JavaScript library) to access OData services via offline OData plugin 318. Datajs is designed to support custom HTTP clients 320 besides its own default implementation. In some implementations, the WebView 308 may also allow access to native device functions via additional plugins (e.g., Cordova/Kapsel plugins) 322. The plugins 322 contain device-specific native code with JAVASCRIPT libraries on top that can be invoked from the application (e.g., hybrid mobile application 306). For example, in addition to the offline OData plugin 318, the plugins 322 may include a logon plugin 324 and a settings plugin 326.

The logon plugin 324 manages the application registration and authentication processes through the SAP Mobile Platform Server or HCPms. It provides a login screen where the user can enter their logon credentials and store them in its own secure data vault. The offline OData plugin 328 provides the client (e.g., device 302) with the ability to define offline stores for OData producers. When an offline store is first opened, it synchronizes with the OData producer. The custom httpClient 320 then resolves all the requests that are made with datajs 316 (for example, OData requests from the FIORI app 310). If the service root of the request matches one of the open stores, that store will serve the request; otherwise the default httpClient 320 is used. The synchronization between the offline stores and the back-end server is explicitly triggered by the FIORI application 310. The plugin provides a flush method to send modifications to the OData producer, and a refresh method to refresh the whole store or a subset of it. The local platform can be used to implement scenarios with no front-end server.

In some implementations, an offline-enabled application can be an enhanced version of the FIORI app 310. The architecture 300 can store a code set for a network connected application version and a code set for an offline-enabled application version.

In some implementations, the plugins 322 can be implemented as an offline store that can be delivered as one or more OData services. For example, the offline OData plugin 328 can be configured as a local (e.g., on device 302) and offline database 323 that stores all data used in the operation of the application 310. The offline OData plugin database can store all data that is available offline for the application 310 and the application 310 may access this database to operate on the data. In some implementations, when the device 302 has network connectivity, the application 310 may not access data that is part of the offline store directly from the backend server 330, but may instead use the local database 323. One offline store can only be used with one OData service and the store is, in general, synchronized with the back-end database 330 regularly when the device has a network connection.

In general, the user interfaces associated with the applications described herein (e.g., FIORI apps, mobile apps, SAP.UI5 applications, etc.) can use datajs 316 (an open source, third-party JAVASCRIPT library) to access OData services. Datajs 316 can support custom HTTP clients and its own default implementation. Utilizing offline OData plugin, you can replace the default HTTP client with a custom implementation that routes the requests to the offline database. Register the set of target URLs that you want to make available offline during the initialization of the offline store. After you have replaced the HTTP client, all OData requests triggered by the application to any of the registered target URLs are going to be served by the OData offline store.

Any number of offline stores can be generated during a first launch of an application. The offline store generation is typically performed using a network connection and successful authentication in order to connect to the back-end server 330. At a later time, a flush operation and a refresh operation can be performed in an asynchronous fashion at the convenience of the user.

In order to provide sufficient data for the end user in the offline mode, the architecture 300 can be used to determine which collections and which subset of these collections are required during offline work. During this process both data volume and functional consistency options may be considered. Such considerations may be analyzed for performance of the architecture.

The content and the structure of the offline store can be configured using a set of defining requests 334 (e.g., requests). A defining request 334 is a static OData read request that targets the OData endpoint (e.g., back-end database 330) associated with the offline store and retrieves a subset of the OData endpoint data. For example, to define offline application settings, the architecture 300 can be used to generate a configuration file 332 that is adapted to configure a mobile platform server. To do so, a user can create an application configuration initialization (.ini) file that includes the defining requests, and other application-specific information. The user can then send the application configuration initialization file to the mobile platform server administrator. The administrator can import the initialization file and configure various offline settings to support the offline application(s).

Multiple defining requests 334 can be defined for each OData endpoint. Defining requests define the subset of data from the OData producer that is sent to the client during initialization of the offline store. Defining requests become fixed for the offline store the first time the request is opened.

One example defining request is shown below. This defining request may be configured to retrieve contacts and related objects, and also ensure a local navigation to the database 323 while offline. There is also a filter defined that determines that a subset of the OData endpoint is synchronized to the local offline store. If a defining request uses $select clauses then it may also include key fields in the select field list (or use the * selectors).

Requests: {

contacts:
“/ContactCollection/?$filter=isMyContact%20eq%20true&$expand=Account/Addresses,
Account/MainAddress
accounts:
“/AccountCollection/?$expand=Addresses,MainAddress
}

Data synchronization between the server and the local device has two directions: changes made on the device (for example, new, updated, and deleted records) are sent to the back end during flush operations and data changes on the back-end server (for example, changes by other users or by the same user as a consequence of its previous flush) are downloaded to the device during refresh operations. The offline SDK provides these two methods as separate operations (flush and refresh), so the application has the flexibility to implement the optimal data synchronization strategy.

Data changes made on the device are stored in a separate request queue. The queue contains the local changes made during offline operation. Data stored in the queue is transmitted to the back end by flush operations; and the queue is emptied.

There are several strategies how data synchronization can be performed in an offline application and it is the responsibility of the application team to evaluate these strategies and select the best option for a particular application. The best strategy might be different for various applications depending on the functionality, number of offline data records, number of new or changed records, and the size of records, usage pattern, and typical user behavior.

The architecture 300 can initiate data synchronization on the device 302 in a number of ways. For example, data synchronization can be initiated manually using buttons or menu items. For example, a pull-to-refresh action can be initiated by a user. The architecture 300 can instead automatically synchronize data when the network connectivity becomes available and/or when the application gets to the foreground (e.g., becomes active) and the device has network connectivity. In another example, the architecture 300 can automatically synchronize data when a new record is created or an existing one is updated and the device has network connectivity. In another example, the architecture 300 can automatically synchronize data after a certain amount of time and the device has network connectivity.

Offline media elements may include media link entity resources that contain structured data and a media resource. The media link entry can be read using datajs while the media resource is a stream that is represented by a URL. The media entity can be read with dataj s. From the response, the stream can be accessed, for example, from the media source (e.g., media_src) property in the metadata.

The media entity may be updated using the datajs library. To update the stream, the code can be programmed to do a PUT against the edit media metadata property of the media entity. The body can be a file from a file input element or a base64 encoded string, provided the content-encoding header is set with a value of base64. ETag should be included with an update. Below is example code for assuming a media_file exists as a file input element in a document object model. The serviceRoot is defined, and an offline store for the service root is open with the custom offline http client applied.

OData.read(serviceRoot + “Drivers(1)”,

function (data, request) {
var file = document.getElementById(“media_file”).files[0],
xhr = new XMLHttpRequest( );
// Use the edit_media link for updating the stream
xhr.open(“PUT”, data._{——}metadata.edit_media, true);
xhr.setRequestHeader(“Accept”, “application/json”);
xhr.setRequestHeader(“if-match”, data._{——}metadata.media_etag);
xhr.onreadystatechange = function( ) {
if (xhr.readyState === 4) {
if (xhr.status === 204) {
// Note that no body for 204 response.
// Use data_{——}metadata.media_src from previous read
console.log(“Media updated. Src: ” + data_{——}metadata.media_src);
} else {
console.log(“Update failed! Status: ” + xhr.status);
}}}
xhr.send(file);
});

A create operation can be performed against the media entity using a POST. The base URL to build the create request is provided in the offlineServiceRoot store property. The body can be a file from a file input element or a base64 encoded string, provided the content-encoding header is set with a value of base64. A create example is shown below. The code snippet below assumes media_file exists as a file input element in the document object model and the store variable is defined and points to the created offline OData store.

var file = document.getElementById(“media_file”).files[0],

url = store.offlineServiceRoot + “Drivers”,
xhr = new XMLHttpRequest( );
xhr.open(“POST”, url, true);
xhr.setRequestHeader(“Accept”, “application/json”);
xhr.onreadystatechange = function( ) {
if (xhr.readyState === 4) {
if (xhr.status === 201) {
var data = JSON.parse(xhr.responseText);
console.log(“Media created.” + “Src: ” + data.d._{——}metadata.media_src);
} else {
console.log(“Request failed! Status: ” + xhr.status);
}}}
xhr.send(file);

In one example implementations, a user can assume Contacts are associated with a ‘parent’ Account, and that in the OData model, a Contact has an account ID as a property. The backend system 330 may support a contact creation that is targeted at the generic collection of Contacts, and the relationship between the newly created Contact and its parent Account is described by setting of the account ID property. That is, when creating a new contact, specify the account ID in the accountID property. When querying the backend system 330 for contacts that are ‘children’ of the specified account, the newly created contact will be provided.

In some implementations, the OData model provides a navigation property of the account that allows accessing ‘child’ contacts. For example, defining the Contact as a navigation property, will return an entity set that contains all the child contacts. By using this navigation link, contacts can be created against this target account instead of the generic contact collection. That is, you POST to AccountCollection( . . . )/Contacts instead of ContactCollection.

To enable navigation between entities in offline mode, particular navigation properties should be specified for a particular local database. There are at least two ways to build relationships in Offline OData (1) Using expands in defining requests and (2) using referential constraints. Use the $expand queries in defining requests to pull related entities and to ensure navigation on the offline store. Use $expand queries to build relationships between entity sets only if delta tracking is enabled at the SMP Server and the OData producer is not using a delta query.

OData relationships (associations in OData V2) can expose referential constraints, which act very much like foreign keys in a database; that is they specify the properties in the two entities that point to each other. Offline OData server can use referential constraints to build relationships. In one example, two sets of data exist (e.g., Customers and Orders) with a relationship between them that exposes a referential constraint. A single defining request can be specified (Customers?$expand=Orders) to retrieve all the data including relationships, or two defining requests can be specified: Customers and Orders. In the latter case, the relationship between Customers and Orders can be detected to determine that it exposes a referential constraint, and builds the relationships automatically.

If delta query is used at the OData server, then the two defining requests using a referential is the only working scenario, since delta with expand is not yet supported neither in SAP Gateway nor in SMP Offline OData. Both methods can be mixed.

SAP.UI5 applications may employ the OData Model classes to manage in-memory models. These models are linked to an underlying OData query that is executed against the actual backend OData service. SAP.UI5 provides a number of APIs that allow applications to retrieve content from these in-memory models and force model loads and refreshes.

Many applications may use more than one root service document. For example, the CRM My Accounts app uses two distinct service documents (one rooted in CRM, the other in ERP). The offline store will be set up to reflect such a requirement. Offline OData may need an offline store that is mapped to a single service document, which means each service document has to be mapped to a corresponding store. The fact that the app is using two (or more) distinct root service documents implies that these OData sources are totally independent of each other. Any relationships (for example, implied navigation between entities across the OData feeds) should be handled at the application level

There may be support for multiple service documents. Pulling data from two or more OData services is fully supported with the Offline OData plugin, as each OData service will simply map to its own offline database file. Each application needs to be configured to reference the correct store—but that would be the case whether it is offline or not, so in terms of configuration or setup it makes no difference as to whether there are one or more stores.

When using multiple OData services in offline mode, each offline store should have its own unique name, each store is mapped to a particular unique URL root and these need to be configured correctly, and the app should replace the dataJS default HTTP client using the applyHttpClient call. This can be performed once after all stores are successfully opened.

Stores are totally independent. Changes to one will have no impact on the other. If the back-end services that these stores reflect are not truly independent, then this might have unexpected side effects on the offline app behavior. For example, if the back-end system exposes two service roots in such a way that updates on entities via one have a side effect of updating entities in the other, and the online app relies on this behavior, then this might have negative consequences on the offline version, as the side effect will not happen in the local stores (until both stores are refreshed)—unless additional app logic is written to replicate this while the app is offline and has not yet refreshed.

Each store has its own flush and refresh APIs. It is up to the app to ensure that these are called appropriately—which may happen together or independently. Calling refresh on one store will not refresh the other store, and vice versa. Each store has its own flush error callback invocations, and its own error archive. How the app combines these or presents them to the user is up to the app developer. Actual queries into the Error Archive are needed to be done separately across stores.

OData calls from the app are routed through the custom HTTP client that is applied after store setup (see above). This HTTP client is configured in a way that URLs received from the application layer are mapped to the appropriate store—one (base) URL per store. The HTTP client assumes that URLs that do not map to a store are to be routed to the original HTTP client that is provided with dataJS. This means that apps are free to decide if they want to handle certain OData services through pure online interactions—allowing apps to have a mixture of online and offline OData services.

If an OData service is used in a defining request, all requests to that service are handled by the offline plugin. This means that for one service root document, we currently cannot make some collections available offline while having online access to others.

There are certain recommendations for a OData services that will make the overall offline experience of a application better. For example, entity types that can be changed by the client application should support ETags. This way the OData producer can detect requests for changes on stale data and return an error to the client (for example, Conflict detection). Collections that are expected to return a large data set for a client should support server-side paging. This improves the overall performance and scalability of the solution. It also helps to avoid certain timeouts by the OData producer for very large data sets. Collections that are expected to return a large data set for a client should support the delta-query.

In many cases, the features of a FIORI application require different implementations for the offline enabled and for the online only scenarios. The application needs to determine at runtime if the offline mode is enabled so the UI and the UI logic can be adapted accordingly.

A flag can be implemented to indicate the offline enabled mode by introducing a new property in the UI5 Component of the Fiori app. For example, set the value of the flag property during the initialization of the component based on the URL parameter that is defined in the config.xml of the Cordova application.

If the visibility (or any other property) of certain UI elements needs to be controlled by the offlineEnabled property, a model can be generated to contain the offline mode flag, and set it for the application's main view in the createContent method of the component. This way the UI elements affected by the offline enablement can be bound to this model directly and the controllers can be kept clear of directly accessing and modifying UI elements.

Function imports cannot be used against the offline store because the service metadata document does not describe what changes may occur as a result of calling them. As a result, OData function imports cannot be added to the defining requests.

Backend search and filtering can be implemented using architecture 300. The filtering of the master list is performed on the frontend server by default, which does not require any adjustment for the offline scenario. However, if it is configured to be done by the back end, some approaches will not work without having network access, such as enterprise search and automatic freestyle search based on the SADL framework.

The offline enabled search has to use the OData $filter parameter by setting filters on the aggregation binding of the master list. To ensure a same result with the offline and the back-end OData service as an online service, implement the filtering in the back end in a way that it only uses the parameters defined in the request. The properties of the filter expression have to be filled in the entity set that is returned by the server and other properties should not be used for filtering. For example, in case of the filter expression $filter=Flag EQ ‘X’, the filter process should use the Flag property only without any extra logic involving other properties, and the entities of the result set should have their Flag property filled with ‘X’ even if it is not displayed in the UI.

The application may contain features that require Internet connection to work, and cannot be substituted by simple UI logic (for example, complex business logic with potential access to other data sources and Google Maps integration). The architecture 300 can be used to disable or hide these features while there is no connectivity.

The offline enabled version of a FIORI application handles relative URLs differently from online apps because the application source files are hosted by the file system of the device. Pictures or other file attachments referred to as /<resource path>/$value are looked up at file:///<app name>/<resource path>/$value. This can be prevented by using the full path, that is <service root url>/<resource path>/$value.

When the application creates a new entity or modifies an existing one, some of the entity properties might be calculated in the backend server, such as the Created On and Created By fields, and the full name of a person based on their first name and last name. Such calculations can be replicated in the frontend server to avoid glitches in the UI until the changes are processed by the backend server.

There are certain error situations related to offline use in FIORI applications. Handling of these errors shall be done in a consistent way by the application itself. The method of error handling is different in online and in offline mode. In the case of an online scenario, an almost immediate response is provided from the OData Producer for every request. For example, an update request returns a 412 status code error message if any of the backend side predictions is evaluated as false. The application provides various solutions to help you to handle situations, such as correcting a field or resending a request. The success callback function of the flush method is called if the flush operation can push the local changes to the back end, even if the data validation fails there and they are rejected. In this case, the onrequesterror event is fired. In an offline scenario the store does not contain any kind of business logic and does not do the same checks as the back end does. When the update of an entity happens locally but on the backend the same entity is already deleted, the offline queue is filled with requests that will all fail when the flush call is initiated.

The failed requests are stored in the ErrorArchive entity set dedicated to each offline store initialized on the device. A query can be made to the ErrorArchive collection the same way as any other OData collection by using, for example, the $filter $top query options to modify the search. Entries of the archive have to be deleted by the application after the issues have been resolved.

One example method to make an application offline-enabled is shown below. A Web IDE project based on the SAPUI5 Mobile Kapsel App Project template may be generated by selecting, in Web IDE, File→New→Project from Template, Next, when specifying initial view, select None in order to get an empty project and delete the following files: index.html, index.js, and logon.js. Copy the content of the folder that contains the Componentjs of a original FIORI application to the root of the project that has just been created, except for the following files:.project.json, neo-app.json, .user.project.json. Right click on a Kapsel project, open Project Settings, and select Device Configuration. Specify an app name and an app ID. The app name should start with com.sap.*. The app ID has to be the same as the registration ID at the SMP server. Select a platform (Android and/or iOS). Select a plugins, including the following minimal set: Logon Manager, Offline OData, Settings, and Network Connection. An application entry point html should be named index.html. Modify an original FIORI index.html or create a new one.

Whenever a Cordova application finishes initialization, it fires the deviceready event. This is the time the FIORI application can be started with the fnStartup function. The FIORI application may use additional SAPUI5 library components to be part of the project, since it works as a standalone application.

In some implementations, offline and logon helper objects can be added to assist offline enablement. For example, an AppOfflinelnterface.js contains this generic functionality to initialize the offline store, and handles the logon process. In some implementations, the offline enablement can include changing the following parts to application-specific values: any occurrence of the package name (e.g., cus.crm.mycontacts), STORE_ID value—it is a unique ID for the OData offline store, applicationEndpoint—it is a relative URL to the OData service, offlineStore object—it contains the store ID and the defining requests (discussed later), loginToSMP function—it contains the smpContext.registrationContext object, which contains some default values to help SMP registration internally, loginToSMP function—it contains the smpContext.applicationld, which is the ID used to register the application in SMP, and setupOffline function—it contains the properties.name value, which is an application-specific name for the store. In addition, changing the serviceUrl value in Configuration.js to the correct value, which is provided by the helper object, and adding the loadMetadataAsync property to the service configuration in Configuration.js, and set its value to true can also be part of enabling offline applications.

To define and initialize the service-specific offline store, the architecture 300 can identify all the defining requests and define the defining requests in the AppOfflinelnterface.js, as part of the offlineStore object:

In some implementations, the architecture 300 can detect offline enablement. For example, the application 310 can determine if it is offline enabled or not. Setting flags and/or determining network connections may be example ways to detect offline enablement.

Data synchronization can be enabled. In one example, a refresh action on the master list triggers the back-end synchronization. In case of a refresh, newly created data is written to the back end during flush operations, and then it is retrieved from the backend during refresh operations. To enable data synchronization, implement the following function, and attach it to the updateStarted event of the list. To enable the manual refresh and flush functionalities for the user, the architecture 300 can be used to create two buttons on the UI (for example, in the footer bar of the list screen), and call the refresh and flush methods of the offline store instance from the event handlers of these buttons.

In some implementations, the architectures described herein can provide an SAP Mobile Platform (SMP). The SMP may provide an integrated platform solution to extend enterprise applications to mobile devices. The SMP may act as a hub that connects enterprise information systems and data sources to mobile devices. In the SMP administration UI, the architecture 300 can be used to create a new application configuration for a Cordova application.

In some implementations, a number of standard or custom plugins can be used in offline access to an application. In order to build a custom plugin into the final binary, the plugin can be stored in a database as a zip file. The zip file has to host one or more folders, each folder serving as root for each plugin. Each folder hosts the source code of one plugin: plugin.xml, www, src and res folders.

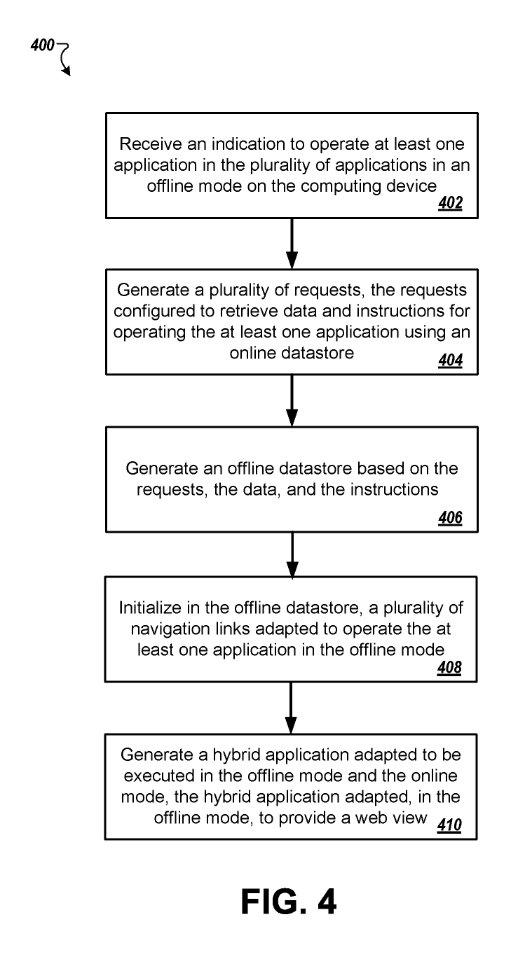

FIG. 4 is a flowchart that illustrates a method of providing an offline mode for a plurality of applications executable on a computing device.

At block 402, the method 400 may include receiving, at a server device, an indication to operate at least one application in the plurality of applications in an offline mode on the computing device. At block 404, the method 400 may include generating a plurality of requests, the requests configured to retrieve data and instructions for operating the at least one application using an online datastore.

At block 406, the method 400 may include generating an offline datastore based on the requests, the data, and the instructions. At block 408, the method 400 may include initializing, in the offline datastore, a plurality of navigation links adapted to operate the at least one application in the offline mode. At block 410, the method 400 may include generating a hybrid application adapted to be executed in the offline mode and/or the online mode, the hybrid application adapted, in the offline mode, to provide a web view to operate the at least one application, on the computing device, using the offline datastore and a plurality of offline libraries.

In some implementations, the hybrid application is further adapted to access offline plugins to operate the at least one application in the offline mode, and wherein the offline mode enables the at least one application to operate without network access. In some implementations, the offline datastore includes a plurality of instructions to map uniform resource locators, received from an application layer of the at least one application, to the offline datastore.

In some implementations, the plurality of requests are configured to retrieve data mapped to a service document, the service document being associated with at least one open protocol data service. In some implementations, the plurality of requests comprise an initialization file having application-specific information and library information for operating the at least one application.

In some implementations, the at least one application is enabled for offline use as a prepackaged application built for at least one mobile platform. In some implementations, the offline datastore is synchronized to the online datastore, in response to detecting network connectivity for the device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

What is claimed is:

1. A computer-implemented method for providing an offline mode for a plurality of applications executable on a computing device, the method comprising:
receiving, at a server device, an indication to operate at least one application in the plurality of applications in an offline mode on the computing device;
generating a plurality of requests, the requests configured to retrieve data and instructions for operating the at least one application using an online datastore;
generating an offline datastore based on the requests, the data, and the instructions;
initializing, in the offline datastore, a plurality of navigation links adapted to operate the at least one application in the offline mode; and
generating a hybrid application adapted to be executed in the offline mode or an online mode, the hybrid application adapted, in the offline mode, to provide a web view to operate the at least one application, on the computing device, using the offline datastore and a plurality of offline libraries.

2. The method of claim 1, wherein the hybrid application is further adapted to access offline plugins to operate the at least one application in the offline mode, and wherein the offline mode enables the at least one application to operate without network access.

3. The method of claim 1, wherein the offline datastore includes a plurality of instructions to map uniform resource locators to the offline datastore, the uniform resource locators being received from an application layer of the at least one application.

4. The method of claim 1, wherein the plurality of requests are configured to retrieve data mapped to a service document, the service document being associated with at least one open protocol data service.

5. The method of claim 1, wherein the plurality of requests comprise an initialization file having application-specific information and library information for operating the at least one application.

6. The method of claim 1, wherein the at least one application is enabled for offline use as a prepackaged application built for at least one mobile platform.

7. The method of claim 1, wherein the offline datastore is synchronized to the online datastore, in response to detecting network connectivity for the device.

8. A computer program product for providing an offline mode for a plurality of applications executable on multiple user interface platforms, the computer program product being tangibly embodied on a non-transitory computer-readable storage medium and comprising instructions that, when executed by at least one computing device, are configured to cause the at least one computing device to:
receive, at a server device, an indication to operate at least one application in the plurality of applications in an offline mode on the at least one computing device;
generate a plurality of requests, the requests configured to retrieve data and instructions for operating the at least one application using an online datastore;
generate an offline datastore based on the requests, the data, and the instructions;
initialize, in the offline datastore, a plurality of navigation links adapted to operate the at least one application in the offline mode; and
generate a hybrid application adapted to be executed in the offline mode or an online mode, the hybrid application adapted, in the offline mode, to provide a web view to operate the at least one application, on the at least one computing device, using the offline datastore and a plurality of offline libraries.

9. The computer program product of claim 8, wherein the hybrid application is further adapted to access offline plugins to operate the at least one application in the offline mode, and wherein the offline mode enables the at least one application to operate without network access.

10. The computer program product of claim 8, wherein the offline datastore includes a plurality of instructions to map uniform resource locators to the offline datastore, the uniform resource locators being received from an application layer of the at least one application.

11. The computer program product of claim 8, wherein the plurality of requests are configured to retrieve data mapped to a service document, the service document being associated with at least one open protocol data service.

12. The computer program product of claim 8, wherein the plurality of requests comprise an initialization file having application-specific information and library information for operating the at least one application.

13. The computer program product of claim 8, wherein the at least one application is enabled for offline use as a prepackaged application built for at least one mobile platform.

14. The computer program product of claim 8, wherein the offline datastore is synchronized to the online datastore, in response to detecting network connectivity for the device.

15. A system for populating and transferring parameters across a plurality of applications executable on multiple user interface platforms, the system comprising:
at least one memory including instructions on a computing device; and
at least one processor on the computing device, wherein the processor is operably coupled to the at least one memory and is arranged and configured to execute the instructions that, when executed, cause the processor to implement,
receiving, at a server device, an indication to operate at least one application in the plurality of applications in an offline mode on the computing device;
generating a plurality of requests, the requests configured to retrieve data and instructions for operating the at least one application using an online datastore;
generating an offline datastore based on the requests, the data, and the instructions;
initializing, in the offline datastore, a plurality of navigation links adapted to operate the at least one application in the offline mode; and
generating a hybrid application adapted to be executed in the offline mode, the hybrid application adapted, in the offline mode, to provide a web view to operate the at least one application, on the computing device, using the offline datastore and a plurality of offline libraries.

16. The system of claim 15, wherein the hybrid application is further adapted to access offline plugins to operate the at least one application in the offline mode, and wherein the offline mode enables the at least one application to operate without network access.

17. The system of claim 15, wherein the offline datastore includes a plurality of instructions to map uniform resource locators to the offline datastore, the uniform resource locators being received from an application layer of the at least one application.

18. The system of claim 15, wherein the requests are configured to retrieve data mapped to a service document, the service document being associated with at least one open protocol data service.

19. The system of claim 15, wherein the at least one application is enabled for offline use as a prepackaged application built for at least one mobile platform.

20. The system of claim 15, wherein the offline datastore is synchronized to the online datastore, in response to detecting network connectivity for the device.
